(19) United States
(12) Patent Application Publication
(10) Pub. No.: US 2016/0140807 A1
(43) Pub. Date: May 19, 2016

(54) METHODS AND APPARATUS FOR MANAGING ONLINE POKER TOURNAMENTS ALLOWING JOINT PLAY BETWEEN USERS POSTING DIFFERING BUY-IN AMOUNTS

(71) Applicant: GTECH UK Interactive Limited, London (GB)

(72) Inventor: Ashley P. Chase, Bromley (GB)

(73) Assignee: GTECH UK Interactive Limited, London (GB)

(21) Appl. No.: 14/543,274

(22) Filed: Nov. 17, 2014

(51) Int. Cl. G07F 17/32

(52) U.S. Cl. CPC G07F 17/3255; G07F 17/3293; G07F 17/3227; G07F 17/3239; G07F 17/3276

(57) ABSTRACT

Techniques for managing an online poker tournament include receiving data transmissions indicating buy-in amounts to participate in the online poker tournament from a plurality of client devices, with buy-in amounts received from first and second client devices being different from buy-in amounts received from third and fourth client devices. The first, second, third, and fourth client devices may be associated in a first set, and the third and fourth client devices may be associated in a second set. Users of all four client devices may participate in the same online poker tournament, and rankings of users in the first and second sets may be determined based on results of the tournament. One or more award amounts for each of the sets may be computed based on the buy-in amounts and the rankings, and notifications of award amounts may be transmitted to client devices.

### BACKGROUND

Online gaming and gambling has become an increasingly popular form of entertainment in recent times. Online gaming infrastructures have developed that make use of large networks such as the Internet to connect players together from diverse geographic locations, sometimes around the globe. Connecting to an online gaming site can allow an individual to compete in approximately real-time against other players with whom he would never otherwise come into contact, at arbitrary times of day, from the comfort of his own home or office computer, without having to physically travel to a casino or other brick-and-mortar gaming site.

One of the earliest and most popular wagering games to be played online is poker, which includes a number of variants, such as Texas hold 'em, Omaha, Seven-card stud, Razz, HORSE, and others. In a traditional poker card game, players sit together at a table and compete to collect winning combinations of cards. At the beginning of each “hand” of the game, typically one or more of the players are required to place an initial bet of some amount (the “blind” or “ante”), and then cards are dealt to the players. Players take turns betting on the strength of the cards that each of them holds (also called the player's “hand” of cards), placing bets in the form of money, “chips” (game betting pieces representing units of value), or other items of value into a “pot” that will be collected by the winner of the hand. In many poker games, there are multiple rounds of betting, separated by periods during which additional cards may be dealt and/or traded. In each round of betting, a player at his turn may either bet or fold (leave the hand and forfeit his contributions to the pot up to that point). After the final betting round, if multiple players remain without folding, then at least some of their hands of cards are revealed, and the player with the strongest hand (as defined by the game rules) wins the pot. Or, if all players but one have folded, then the remaining player may take the pot, possibly without showing his hand of cards.

In a poker tournament, multiple hands of poker are played in sequence, and the winner of the tournament is typically the player who succeeds in winning all of the chips at play in the tournament (i.e., all of the other players' chips, plus his own starting chips). To participate in the tournament, each player typically pays a fixed buy-in amount and is given a fixed starting number of chips to play with. The buy-ins form a prizepool from which the tournament's winnings are drawn. If there are a large number of players in the tournament, they may begin the tournament divided into multiple tables of players, which may be consolidated into fewer numbers of tables as individual players are eliminated from play. All players other than the winner typically become eliminated at some point during the tournament, by losing all of their chips. Once the tournament has been won, in some cases the winner may be awarded all of the prize money. In other cases, the winner may be awarded the largest portion of the prize money, and one or more other players may be awarded smaller portions based on when they were eliminated from the tournament (e.g., the last player to be eliminated may be awarded the next-largest portion of the prize money, etc.).

Online poker tournaments are typically hosted by a server, such as a web server, to which players from potentially anywhere in the world can connect to play together as if they were in the same room. Each player typically participates in the tournament via a client device (such as a personal computer) that communicates with the server via a network such as the Internet. The server manages and continually updates a database storing the information used in running the online poker tournament, such as user profiles, player chip amounts, player table assignments, player hands, player bets, game cards, and the like. The server transmits information to and receives corresponding information from the client devices in data transmissions via the network. The server device processes information it receives, such as new user actions or user profile changes, updates the database as to the current game state in as close to real-time as possible, and transmits continuously updating graphics and messages to the client devices to maintain on each client device a real-time display of the virtual poker tournament in progress.

### SUMMARY

One type of embodiment is directed to a server system for managing an online poker tournament allowing joint play between users posting different buy-in amounts, the server system comprising at least one communication interface configured to communicate over a network with a plurality of client devices including at least a first client device, a second client device, a third client device, and a fourth client device, at least one processor, and at least one processor-readable storage medium storing processor-executable instructions that, when executed by the at least one processor, cause the at least one processor to: receive, via the at least one communication interface, data transmissions indicating buy-in amounts to participate in the online poker tournament from at least the first client device, the second client device, the third client device, and the fourth client device, wherein a buy in amount from the first client device and a buy in amount from the second client device are different from a buy in amount from the third client device and a buy in amount from the fourth client device; associate, based on the buy-in amounts, the first client device, the second client device, the third client device, and the fourth client device in a first set of client devices, and the third client device and the fourth client device in a second set of client devices; manage administration of the online poker tournament, in communication with the first client device, the second client device, the third client device, and the fourth client device via the at least one communication interface; determine, based on results of the administered online poker tournament, first set rankings of users of the first set of client devices, and second set rankings of users of the second set of client devices; compute, based on the buy-in amounts and the first set rankings, one or more first set award amounts; compute, based on the buy-in amount from the third client device, the buy-in amount from the fourth client device, and the second set rankings, one or more second set award amounts; transmit, via the at least one communication interface, notification of at least one of the first set award amounts to at least one client device of the first set of client devices; and transmit, via the at least one communication interface, notification of at least one of the second set award amounts to at least one client device of the second set of client devices.

Another type of embodiment is directed to a method for managing an online poker tournament allowing joint play between users posting different buy-in amounts, the method comprising: receiving, via at least one communication interface, data transmissions indicating buy-in amounts to participate in the online poker tournament from a plurality of client devices including at least a first client device, a second client device, a third client device, and a fourth client device, wherein a buy in amount from the first client device and a buy in amount from the second client device are different from a buy in amount from the third client device and a buy in amount from the fourth client device; associating, based on the buy-in amounts, the first client device, the second client device, the third client device, and the fourth client device in a first set of client devices, and the third client device and the fourth client device in a second set of client devices; managing administration of the online poker tournament, via execution of stored instructions by at least one processor, in communication with the first client device, the second client device, the third client device, and the fourth client device via the at least one communication interface; determining, based on results of the administered online poker tournament, first set rankings of users of the first set of client devices, and second set rankings of users of the second set of client devices; computing, via execution of the stored instructions by the at least one processor, based on the buy-in amounts and the first set rankings, one or more first set award amounts; computing, via execution of the stored instructions by the at least one processor, based on the buy-in amount from the third client device, the buy-in amount from the fourth client device, and the second set rankings, one or more second set award amounts; transmitting, via the at least one communication interface, notification of at least one of the first set award amounts to at least one client device of the first set of client devices; and transmitting, via the at least one communication interface, notification of at least one of the second set award amounts to at least one client device of the second set of client devices.

Another type of embodiment is directed to at least one processor-readable storage medium encoded with processor-executable instructions that, when executed by at least one processor, perform a method for managing an online poker tournament allowing joint play between users posting different buy-in amounts, the method comprising: receiving, via at least one communication interface, data transmissions indicating buy-in amounts to participate in the online poker tournament from a plurality of client devices including at least a first client device, a second client device, a third client device, and a fourth client device, wherein a buy in amount from the first client device and a buy in amount from the second client device are different from a buy in amount from the third client device and a buy in amount from the fourth client device; associating, based on the buy-in amounts, the first client device, the second client device, the third client device, and the fourth client device in a first set of client devices, and the third client device and the fourth client device in a second set of client devices; managing administration of the online poker tournament, in communication with the first client device, the second client device, the third client device, and the fourth client device via the at least one communication interface; determining, based on results of the administered online poker tournament, first set rankings of users of the first set of client devices, and second set rankings of users of the second set of client devices; computing, based on the buy-in amounts and the first set rankings, one or more first set award amounts; computing, based on the buy-in amount from the third client device, the buy-in amount from the fourth client device, and the second set rankings, one or more second set award amounts; transmitting, via the at least one communication interface, notification of at least one of the first set award amounts to at least one client device of the first set of client devices; and transmitting, via the at least one communication interface, notification of at least one of the second set award amounts to at least one client device of the second set of client devices.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an exemplary operating environment for a system for managing an online poker tournament according to some embodiments;

FIG. 2 is a block diagram of the exemplary operating environment of FIG. 1 illustrating exemplary components of a server system according to some embodiments;

FIGS. 3A-3C illustrate exemplary computations for tiers, buy-ins and prizepools according to some embodiments;

FIGS. 4A-4D illustrate exemplary user interface views according to some embodiments;

FIGS. 5A-5B illustrate exemplary computations for rank positions and award amounts according to some embodiments;

FIGS. 6A-6C are flowcharts illustrating exemplary methods for managing online poker tournaments allowing joint play between players posting differing buy-in amounts according to some embodiments; and

FIG. 7 is a schematic diagram of an exemplary computing environment in which some embodiments may be implemented.

### DETAILED DESCRIPTION

Conventional online poker tournaments require a fixed, single buy-in amount, and the inventor has recognized that this may not always be optimal for promoting user interest and satisfaction with the online gaming system. In a conventional system, for example, the host server would establish a single fixed buy-in amount for a given tournament—say, $15—and each player desiring to participate in that tournament would be required to contribute the established buy-in amount of $15. If a particular player would rather play for a different buy-in amount—say, $10—then that player would need to find a different tournament with a $10 buy-in, and would not be able to participate in the first tournament together with the $15 players.

The inventor has appreciated that potential players may have diverse economic circumstances and preferences. Wealthy or extravagant players may prefer tournaments with higher buy-in amounts which create the possibility of winning larger prizes. On the other hand, less wealthy or more frugal players may prefer tournaments with lower buy-in amounts for which they can afford or justify the investment. The inventor has appreciated that this may be particularly true in the case of online gaming, which may allow for management of tournaments with significantly lower buy-in amounts than those that take place in brick-and-mortar casinos. Online gaming systems may have the capability of using high-capacity computing resources to concurrently manage games for very large numbers, e.g., thousands or even millions, of simultaneous players, which may make quite a wide range of buy-in amounts feasible with economies of scale. Many of these online players may be casual or intermittent participants, and many may be looking for a cheap way to experience casino-type gaming without significantly affecting their budgets. Other online players, on the other hand, may be seeking greater challenges, thrills, or potential winnings from their gaming, and the inventor has recognized that these different types of players conventionally choose different tournaments with different buy-in amounts, such that they remain segregated and do not play against each other.

The inventor has recognized, however, that there may be many reasons why a first player or players desiring a lower buy-in amount may want to play together with a second player or players desiring a higher buy-in amount. For example, the first and second players may be friends or acquaintances, or may share a similar level of experience, skill, or style, but cannot agree to the same buy-in amount. As another example, the first player may want to have an opportunity to play with or learn from the second player, who has a higher skill level but only plays in tournaments with higher buy-in amounts than the first player can afford or justify. In a conventional online poker tournament system, as the inventor has recognized, such players cannot play together in the same tournament.

The inventor has appreciated that more players with diverse economic circumstances and preferences may be able to play against each other in the same online poker tournament with a system that supports multiple buy-in amounts for a single online poker tournament. The inventor has also appreciated that such a system may enable a given online poker tournament to have a larger field of players and larger prizepools than a conventional tournament, which may benefit all players in the tournament.

Accordingly, some embodiments described herein relate to techniques for managing online poker tournaments, which may address one or more of the above-discussed shortcomings of traditional methods, and/or that may provide one or more of the foregoing benefits. However, embodiments are not limited to any of these benefits, and it should be appreciated that some embodiments may not provide all or any of the above-discussed benefits and/or may not address all or any of the above-discussed deficiencies that the inventor has recognized in conventional techniques.

In some embodiments, a server system for managing an online poker tournament allowing joint play between users posting different buy-in amounts may communicate over a network with client devices operated by players participating in the online poker tournament. The server system may receive data transmissions indicating buy-in amounts from the client devices, with different client devices indicating different buy-in amounts for the same online poker tournament. In some embodiments, the server system may associate the client devices into sets based on their buy-in amounts. For example, in some embodiments, the server system may group together client devices that post the same or similar buy-in amounts to each other, in a different tier from other client devices grouped around a different buy-in amount. In some embodiments, as described further below, the client devices' buy-in tiers may determine their association into different prizepool sets that may be treated differently in terms of potential winnings from the tournament. The server system may then manage administration of the online poker tournament in communication with the client devices, with users (players) of client devices in different buy-in tiers participating together the same tournament. In some embodiments, the tournament may include at least one hand in which players in different buy-in tiers participate together in the same hand.

Based on the gameplay in the tournament, the server system may determine rankings of the users of the client devices for each set. For example, in some embodiments, the server system may determine overall rankings of all the users in the tournament (e.g., based on their sequence of elimination from the tournament). Alternatively or additionally, in some embodiments, the server system may determine rankings of users within a particular prizepool set (e.g., with the last player in set A to be eliminated from the tournament ranking first in set A, the next-latest player in set A to be eliminated ranking second in set A, etc.). In some embodiments, the server system may compute award amounts for a particular prizepool set based on the applicable buy-in amounts and rankings, and may transmit notification of the computed award amounts to one or more of the client devices in that set. For example, in some embodiments, the buy-in amounts or portions of the buy-in amounts from a particular set of client devices may contribute to a prizepool for that set of players, which may be distributed to one or more of the players in that set based on the rankings of players in that set. In these ways, in some embodiments, players posting different buy-in amounts may participate together and play against each other in the same tournament, while still having access to different prizepool amounts and different levels of potential winnings based on the amounts of their buy-ins.

It should be appreciated that the foregoing description is by way of example only, and embodiments are not limited to providing any or all of the above-described functionality, although some embodiments may provide some or all of the functionality described herein.

The embodiments described herein can be implemented in any of numerous ways, and are not limited to any particular implementation techniques. Thus, while examples of specific implementation techniques are described below, it should be appreciated that the examples are provided merely for purposes of illustration, and that other implementations are possible.

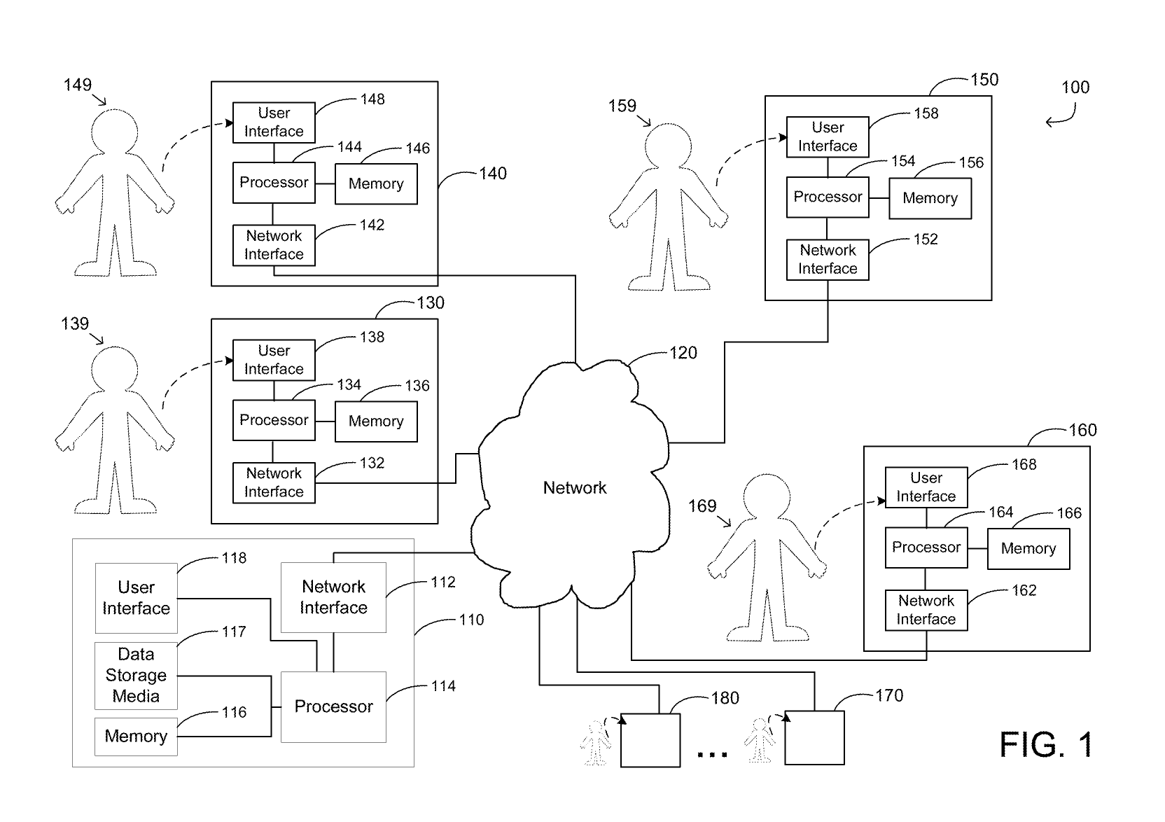

One illustrative application for the techniques described herein is for use in a system for managing an online poker tournament. An exemplary operating environment for such a system is illustrated in FIG. 1. The exemplary operating environment 100 includes a server system 110, which may be implemented in any suitable form, as embodiments are not limited in this respect. For example, server system 110 may be implemented as a single stand-alone machine, or may be implemented by multiple distributed machines that share processing tasks in any suitable manner. Server system 110 may be implemented as one or more computers; an example of a suitable computer is described below. In some embodiments, server system 110 may include one or more tangible, non-transitory processor-readable storage devices storing processor-executable instructions, and one or more processors that execute the processor-executable instructions to perform functions described herein. The storage devices may be implemented as computer-readable storage media (i.e., tangible, non-transitory computer-readable media) encoded with the processor-executable instructions; examples of suitable computer-readable storage media are discussed below.

As depicted, exemplary server system 110 includes a network interface 112, one or more processors 114, memory 116, data storage media 117, and a user interface 118. The server system 110 may be in communication, via the network interface 112 and a network 120, with any number of client devices. Network 120 may be any suitable data transmission network carrying communications between client devices and server system 110, such as one or more local networks and/or wide-area networks such as the Internet, and may include any suitable number and/or type(s) of connections, including wired and/or wireless network connections. In some embodiments, server system 110 may, through execution of computer instructions by processor(s) 114, perform techniques described herein to manage an online poker tournament in communication with participating client devices, among other potential functions of server system 110.

The example environment depicted in FIG. 1 includes but is not limited to first client device 130, second client device 140, third client device 150, fourth client device 160, and other client devices including client devices 170 and 180, among other possible client devices. Although first through fourth client devices are explicitly described for purposes of illustration of various techniques disclosed herein, it should be appreciated that any number of client devices may participate in some embodiments. In some cases, there may be up to hundreds of thousands of players or more participating in the same online poker tournament, involving similar numbers of client devices communicating with the one or more computers of server system 110 hosting and managing the tournament.

Each of the client devices in the example of FIG. 1 includes a network interface (132, 142, 152, 162, etc.), one or more processors (134, 144, 154, 164, etc.), memory (136, 146, 156, 166, etc.), and a user interface (138, 148, 158, 168, etc.). Client devices 170 and 180 (as well as other client devices) may include similar components (not shown). These similar components may serve similar functions for any or all the client devices. In some embodiments, the one or more processors of a client device may execute instructions stored in the memory to communicate with server system 110 to participate in an online poker tournament, and to display information received from server system 110 and graphical views representing the tournament via the user interface. The server system 110 may communicate with each client device via the server system's network interface 112, the network 120, and the network interface of the respective client device. A user (referred to interchangeably herein as player, which a user may become by joining a tournament) (139, 149, 159, 169, etc.) may operate each client device via its respective user interface.

In some embodiments, the processor(s) 114 of server system 110 may execute instructions stored in memory 116 and/or in data storage media 117 that cause the server system 110 to receive, via the network interface 112, data transmissions indicating buy-in amounts to participate in the online poker tournament from client devices (e.g., the first client device 130, the second client device 140, the third client device 150, and the fourth client device 160). A buy-in amount from some client devices (e.g., the first client device 130 and the second client device 140) may be different from a buy-in amount from other client devices (e.g., the third client device 150 and the fourth client device 160).

In some embodiments, each of the buy-in amounts from a first group of client devices (e.g., the first client device 130 and the second client device 140) may be less than each of the buy-in amounts from a second group of client devices (e.g., the third client device 150 and the fourth client device 160). Thus, in some embodiments, client devices such as first client device 130 and second client device 140 may be grouped in a tier characterized by lower buy-in amounts than those posted by client devices such as third client device 150 and fourth client device 160, which may be grouped in a different tier. The buy-in amounts from client devices grouped in the same tier may be the same as one another in some embodiments, or may be somewhat different from one another in other embodiments. For example, in some embodiments, each of the buy-in amounts from the first group (e.g., the first client device 130 and the second client device 140) may be equal to a first buy-in amount, and each of the buy-in amounts from the second group of client devices (e.g., the third client device 150 and the fourth client device 160) may be equal to a second buy-in amount. For instance, in one particular example used for illustrative purposes herein, the buy-in amounts from the first client device 130 and the second client device 140 may each be 10 dollars, and the buy-in amounts from the third client device 150 and the fourth client device 160 may each be 15 dollars.

Buy-in amounts may be determined in any suitable way. In some embodiments, server system 110 may specify multiple fixed buy-in amounts for a given online tournament, such that each client device's buy-in data transmission to server system 110 includes a selection of one of the available specified buy-in amounts. For example, in some embodiments, the processor(s) 114 of server system 110 may execute stored instructions to specify the first, second, and any other suitable buy-in amounts for a particular online poker tournament, and to transmit notification of the specified buy-in amounts to the client devices prior to receiving the data transmissions back from the client devices to indicate (e.g., select) their respective buy-in amounts. For example, the specified buy-in amounts may be stored in buy-in amounts tables and/or any other suitable data structure in one or more databases 119 or other suitable data storage structures (all referred to herein as “databases”) stored by the data storage media 117, and may be retrieved by the processor(s) 114 so that the notification can be transmitted via the network interface 112, the network 120, and the network interfaces of the client devices. In some embodiments, having centrally specified buy-in amounts may simplify tournaments and attract players, allowing a tournament organizer to target specific buy-in amount preferences of potential players, if desired.

In some embodiments, server system 110 may specify fixed buy-in amounts utilizing any suitable limitations on the range of buy-in amounts to be supported, the relationships between buy-in amounts within the same tournament, and/or any other suitable criteria. For example, in some embodiments, specifying the buy-in amounts may comprise setting one buy-in amount to be no greater than about double another buy-in amount. For instance, in accordance with the running example introduced above, the processor(s) 114 of server system 110 may execute instructions to specify a first buy-in amount as 10 dollars, a second buy-in amount as 15 dollars, and a third buy-in amount as 20 dollars, where the highest buy-in amount is no more than double the lowest buy-in amount. The inventor has appreciated that setting such a limit in some embodiments may reduce the motivation for fraud by users. For example, if the user 139 of the first client device 130 were to coordinate with the user 159 of the third client device 150 so that the first client device 130 submitted a buy-in amount of 10 dollars, and the third client device 150 were allowed to submit a much larger buy-in amount of 100 dollars, user 139 could then deliberately lose hands to user 159, which could fraudulently increase user 159's winnings (which he may then share with user 139). The inventor has appreciated that appropriately set limitations on factors such as the range of buy-in amounts allowed within a tournament may be effectively utilized in some embodiments to reduce the incentive for this type of fraudulent behavior.

In some other embodiments, the processor(s) 114 of server system 110 may execute instructions to accept buy-in amounts indicated by the data transmissions from client devices, without specifying particular buy-in amounts for each buy-in tier prior to receiving the data transmissions. For example, in some embodiments, each user of a client device may manually enter a buy-in amount desired by that user (e.g., via a text-entry field or other suitable method of data entry), which need not be equal to or within a given range of any other buy-in amount entered by any other user. On the other hand, in some embodiments, the processor(s) 114 of server system 110 may execute instructions to reject or reduce a buy-in amount indicated in the data transmissions that is greater than about double another buy-in amount indicated in the data transmissions. For example, if one buy-in amount is 10 dollars, the processor(s) 114 of server system 110 may execute instructions to reject a more recent buy-in amount of 30 dollars and/or automatically reduce the more recent buy-in amount to 20 dollars.

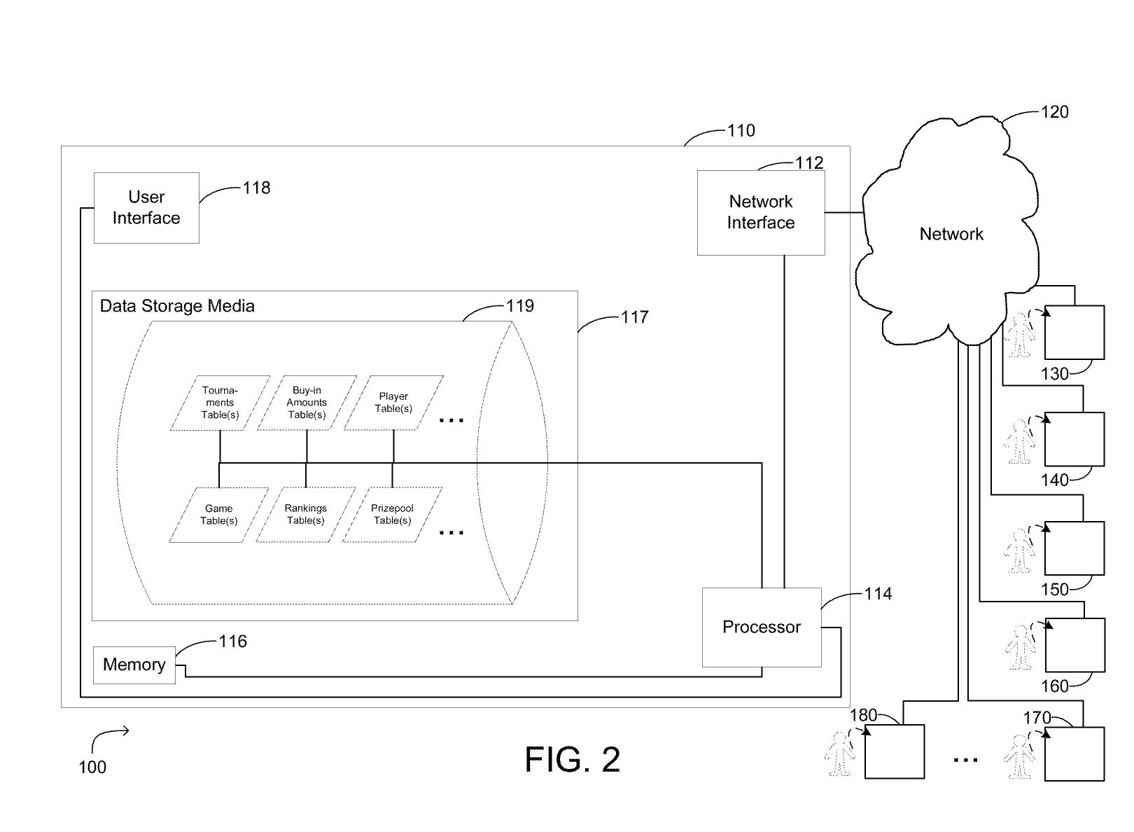

In some embodiments, the processor(s) 114 may receive the client devices' buy-in amounts via the network interface 112 and update a data table or any other suitable data structure (all referred to herein as “data tables”) in a database stored by the data storage media 117 with the received buy-in amounts. For example, the processor(s) 114 may update buy-in amounts tables, tournaments tables, players tables, and/or any other tables impacted by the buy-in amounts. An exemplary database 119 with data tables stored by the data storage media 117 is illustrated in FIG. 2. These data tables, in various embodiments, may include tournaments tables, buy-in amounts tables, players tables, game tables, rankings tables, and/or prizepool tables, and so on. However, it should be appreciated that these examples are provided merely for purposes of illustration, and that some embodiments may not make use of all or any of these exemplary data structures, and that some embodiments may include additional suitable data structures not described as examples herein. Data involved in managing online tournaments may be stored, processed, and/or updated in any suitable way using any suitable data management techniques, as embodiments are not limited in this respect.

In some embodiments, the processor(s) 114 of server system 110 may execute stored instructions to associate the client devices, based on the buy-in amounts, in a first set of client devices, a second set of client devices, and any other number of sets of client devices appropriate to accommodate the buy-in amounts received. In some embodiments, this may involve associating client devices into sets based on their selections among the fixed buy-in amounts specified by server system 110. For example, in some embodiments a first buy-in tier of client devices may include client devices selecting the first (lower) specified buy-in amount, a second buy-in tier of client devices may include client devices selecting the second (higher) specified buy-in amount, etc. In some embodiments, the client devices in both the first tier and the second tier may be associated in the first prizepool set, while the client devices in the second tier (but not the client devices in the first tier) may be associated in the second prizepool set. However, embodiments are not limited to this scenario. In other embodiments, for example, the buy-in tiers may be the same as the prizepool sets.

In embodiments in which buy-in amounts may be manually specified by users of client devices, associating the client devices into sets may involve any suitable computations performed by server system 110 to group the client devices according to any suitable criteria. For instance, in one example, any suitable set of thresholds may be set, such that client devices are grouped into, e.g., a tier for buy-in amounts of 10 dollars or less, a tier for buy-in amounts of more than 10 dollars but not more than 20 dollars, etc. In some embodiments, such thresholds may be adapted based on the buy-in amounts received, to achieve a desired number of tiers and/or a desired approximate number or percentage of client devices in each tier. In some embodiments, any suitable known clustering algorithm may be applied to divide client devices into a desired number of tiers in which client devices within the same tier have similar buy-in amounts to each other. Any such criteria may be configured in any suitable way, e.g., by a developer of server system 110 for managing the online tournament. Client devices grouped in buy-in tiers may then be associated with prizepool sets in any suitable manner, e.g., as discussed above and further below.

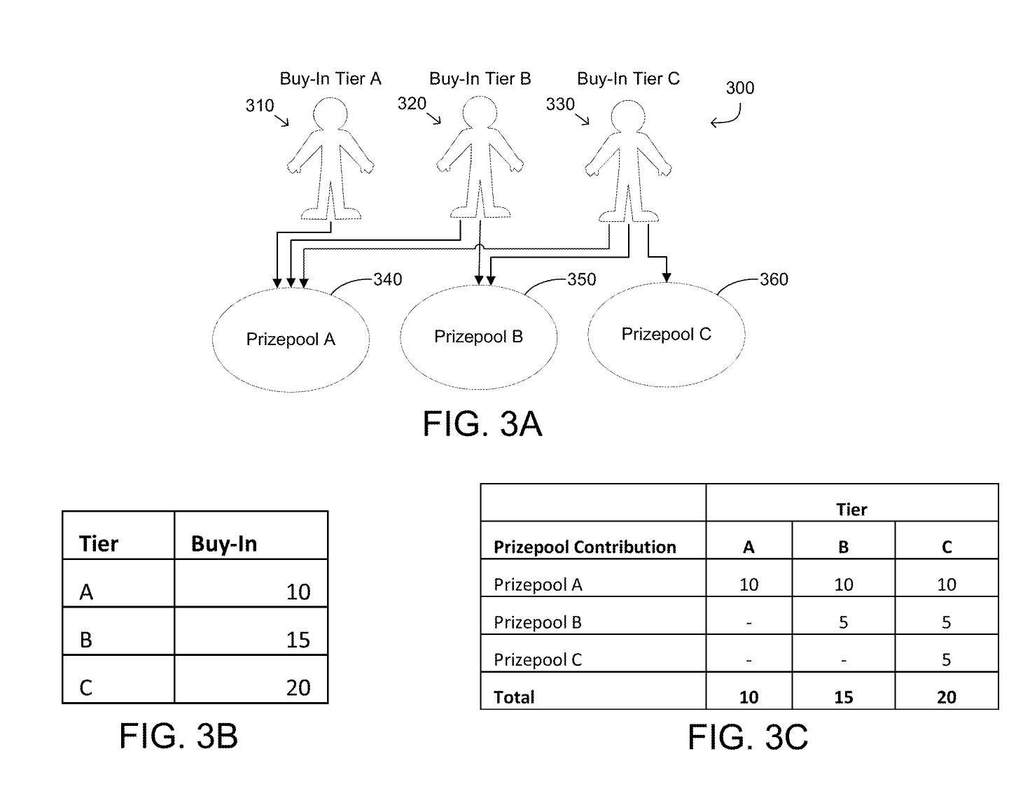

For instance, in the running example introduced above, the processor(s) 114 of server system 110 may execute instructions to associate the first client device 130, the second client device 140, the third client device 150, and the fourth client device 160 (possibly together with other client devices) in a first set because their buy-in amounts are all equal to or greater than 10 dollars. Put another way, first client device 130 and second client device 140 may be grouped in a first buy-in tier based on their buy-in amount of 10 dollars, and third client device 150 and fourth client device 160 may be grouped in a second buy-in tier based on their buy-in amount of 15 dollars, and then both buy-in tiers may be associated in the first prizepool set for buy-in amounts of 10 dollars or greater. The processor(s) 114 may further execute instructions to associate the third client device 150 and the fourth client device 160 (possibly together with other client devices) in a second set because their buy-in amounts are both 15 dollars, while the buy-in amounts from the first client device 130 and the second client device 140 are only 10 dollars each. Put another way, client devices in the second buy-in tier of 15 dollars may be associated in the second prizepool set, without the client devices of the first buy-in tier. In this example, other client devices indicating buy-in amounts of 20 dollars may be grouped in a third buy-in tier, which may be associated in both the first and second sets, as well as in an additional third set in which the first and second buy-in tiers do not participate. This example is illustrated further below with reference to FIGS. 3A-3C.

In some embodiments, the processor(s) 114 of server system 110 may execute instructions to transmit to each client device a list of users of client devices in one or more sets of client devices to which the respective client device is associated. For example, if player 1 is using a client device associated to a first set of client devices, the processor(s) 114 may execute instructions to transmit to that client device a list of users of client devices in the first set, which may include, e.g., players 1 through 10. As another example, if player 9 is using a client device associated to a third buy-in set of client devices, the processor(s) 114 may execute instructions to transmit to that client device a list of users of client devices in the third set, which may include, e.g., players 9 and 10. Additionally, in some embodiments, the processor(s) 114 may execute instructions to transmit to the client device in the third set a list of users of client devices in the first and second sets, separately from or together with the list of users of client devices in the third set.

In some embodiments, server system 110 may, through execution of stored instructions by processor(s) 114, perform any suitable computations to determine available prizepools based on the multiple buy-in amounts from client devices participating in the same online tournament. An exemplary way of determining buy-in tiers and prizepool sets based on client device buy-in amounts (using the running example introduced above with buy-in amounts of 10 dollars, 15 dollars, and 20 dollars) is illustrated in FIGS. 3A, 3B, and 3C. An illustration 300 of this exemplary association between tiers and prizepools is provided in FIG. 3A. The association between tiers and buy-in amounts is illustrated in tabular form in FIG. 3B, and the contributions to each prizepool from each client device in each tier are illustrated in FIG. 3C. In this example, each tier corresponds to a set of client devices grouped together with the same or similar buy-in amount. In this example, tier A 310 may include only those client devices whose buy-in amounts are 10 dollars—e.g., the first client device 130 and the second client device 140, in the example given above. Tier B 320 may include only those client devices whose buy-in amounts are 15 dollars—e.g., the third client device 150 and the fourth client device 160, in the example given above. Tier C 330 may include only those client devices whose buy-in amounts are 20 dollars. At a further level, in some embodiments, client devices in various buy-in tiers may participate in various suitable combinations in prizepool sets. A prizepool may be considered a pool of all or some portion of the buy-in amounts from the client devices in each set. In some embodiments, the buy-in amount from a user may determine which prizepool(s) the user may compete for.

In some embodiments, the processor(s) 114 of server system 110 may execute instructions to compute a prizepool amount for each set based at least in part on all of or a portion of the buy-in amounts from the client devices in that set, and to transmit, via the network interface 112, notification of the prizepool amount for that set to all the client devices or to the client devices in that set. In some embodiments, the portion of a client device's buy-in amount included in a higher set's prizepool may be the amount not included in any lower set's prizepool. For example, the second set prizepool amount may be computed based on portions of the buy-in amounts from the client devices in the second set not included in the first set prizepool amount. As a more specific example, the second set prizepool amount may include the difference between the total buy-in amount for that set and the portion contributed to the first set prizepool amount. That is, in the running example, the second set prizepool amount may include 5 dollars from each client device in the second set, each of which contributed 10 dollars (to match the first buy-in tier) to the first set prizepool amount from a total buy-in amount of 15 dollars.

Alternatively, in some embodiments the server system 110 may take a “cut” of any or all of the buy-in amounts such that the prizepool amounts may not be an exact sum of the buy-in amounts as described above. In some embodiments, for example, the server system 110 may charge a usage fee to the client devices for providing its services, which may decrease the buy-in amounts indicated by the client devices before server system 110 performs the calculations to compute the prizepools from the remaining amounts. Such a usage fee may be determined in any suitable way, such as a flat fee for each player participating in the tournament, or a percentage of the player's buy-in amount, or any other suitable fee arrangement.

In some embodiments, the processor(s) 114 of server system 110 may execute instructions to transmit, via the network interface 112, notifications of available prizepool amounts to client devices participating in the tournament. In some embodiments, notification of a set's prizepool amount may be transmitted to all the client devices (e.g., including to client devices not eligible for that particular prizepool), e.g., as well as notification of which of the set prizepool amounts the user of each client device is eligible to compete for. Alternatively, in some embodiments the processor(s) 114 of server system 110 may execute instructions to transmit, via the network interface 112, notification of a set's prizepool amount to the client devices in that set and not to the client devices not in that set.

In some embodiments, only the users of client devices in a set that contributes to a given prizepool may receive a prize from that prizepool. In the example of FIG. 3A, prizepool A 340 may include contributions from the client devices in the first set, which includes the client devices of tier A 310, tier B 320, and tier C 330. Prizepool B 350 may include contributions from the client devices in the second set, which includes the client devices of tier B 320 and tier C 330. Finally, prizepool C 360 may include contributions from the client devices in the third set, which includes the client devices of tier C 330. Thus, in some embodiments, players in a given buy-in tier may participate in the prizepool associated with that tier as well as all prizepools associated with lower buy-in tiers. It should be appreciated, however, that this is merely an example, and other ways of mapping buy-in tiers to prizepool sets are possible in some embodiments. In some embodiments, any suitable mapping involving a prizepool being shared by players in multiple buy-in tiers may be utilized. For instance, in another example, players in buy-in tier A may participate only in prizepool A, players in buy-in tier B may participate in prizepools A and B, and players in buy-in tier C may participate in prizepools A and C (without participating in prizepool B).

In some embodiments, manually entered buy-in amounts may be associated with tiers and prizepools using more complex calculations. For example, if the buy-in amounts from eight client devices are 8 dollars, 9 dollars, 10 dollars, 14 dollars, 16 dollars, 17 dollars, 21 dollars, 23 dollars, and so on, the processor(s) 114 of server system 110 may, through execution of stored instructions, associate the buy-in amounts of 8 dollars, 9 dollars, and 10 dollars in tier A, the buy-in amounts of 14 dollars, 16 dollars, and 17 dollars in tier B, and the buy-in amounts of 21 dollars and 23 dollars in tier C. The processor(s) 114 may further calculate appropriate prizepools and appropriate contributions to each prizepool based on these buy-in amounts in any suitable way.

The processor(s) 114 of server system 110 may execute further stored instructions to manage administration of the online poker tournament, in communication with the client devices via the network interface 112, the network 120, and the network interfaces of the client devices (e.g., 132, 142, 152, 162, etc.). In some embodiments, this may include administering at least one hand of poker in the online poker tournament in which users of client devices posting different buy-in amounts may participate in the same hand.

Managing administration of the online poker tournament may include the server system, in some embodiments, transmitting content to the client devices, which then may display the received content on their respective user interfaces to their users. The server device may receive data from client devices operated by large numbers of users (e.g., tens, hundreds, thousands, tens or hundreds of thousands of users, or more) and may manage all the information in one or more databases and/or other suitable data structures. The server system may prepare the tournament by assigning players to tables, calculating the appropriate prizepools, and transmitting appropriate information to the client devices associated with the tournament, such as the amounts of the prizepools, the chip amounts of each player in the tournament, player table assignments, and/or the like.

When the tournament play begins, the server system may calculate player hands and any other suitable information, e.g., using random number generation to simulate the luck of the draw and randomly shuffled decks of cards in play, and may transmit data to the appropriate client devices to allow the current state of the game to be displayed to each user as if he were playing in a real-world tournament. Players may enter actions such as betting, checking, or folding into the user interfaces of their client devices, which may transmit data indicating the actions to the server system. The server system may process incoming data from large numbers of client devices representing actions taking place at multiple tables of the poker tournament concurrently, and may maintain its data sets continuously updated with current game states and statistics, continuously transmitting updated data to the client devices to create for their users a real-time experience of observing and participating in a virtual poker game with the other players at their tables.

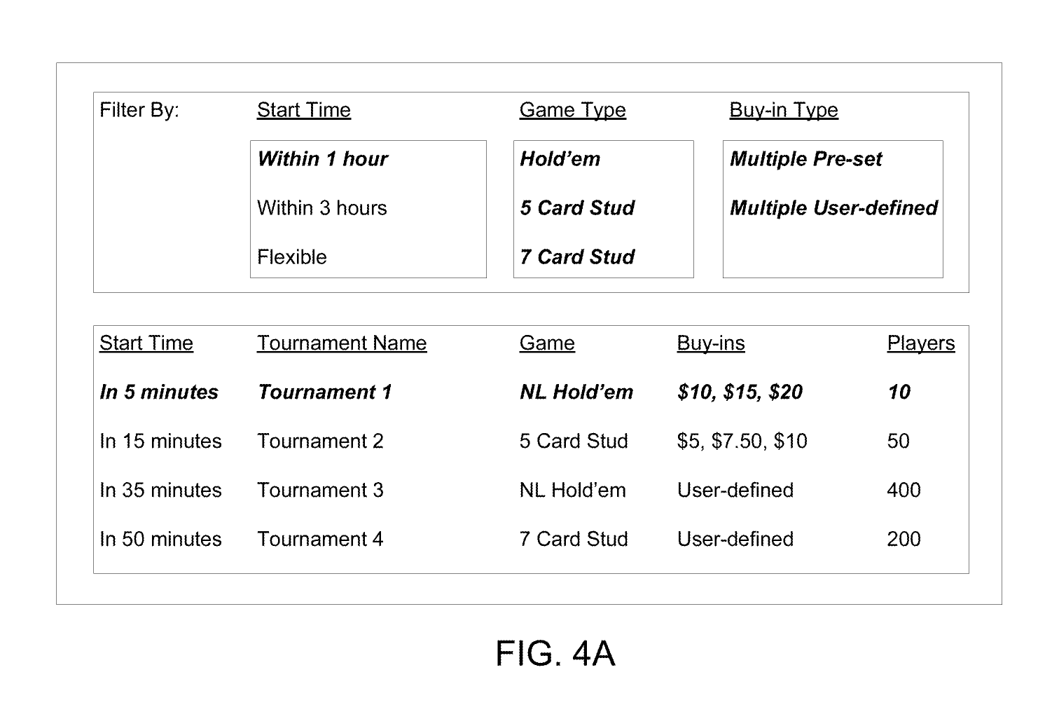

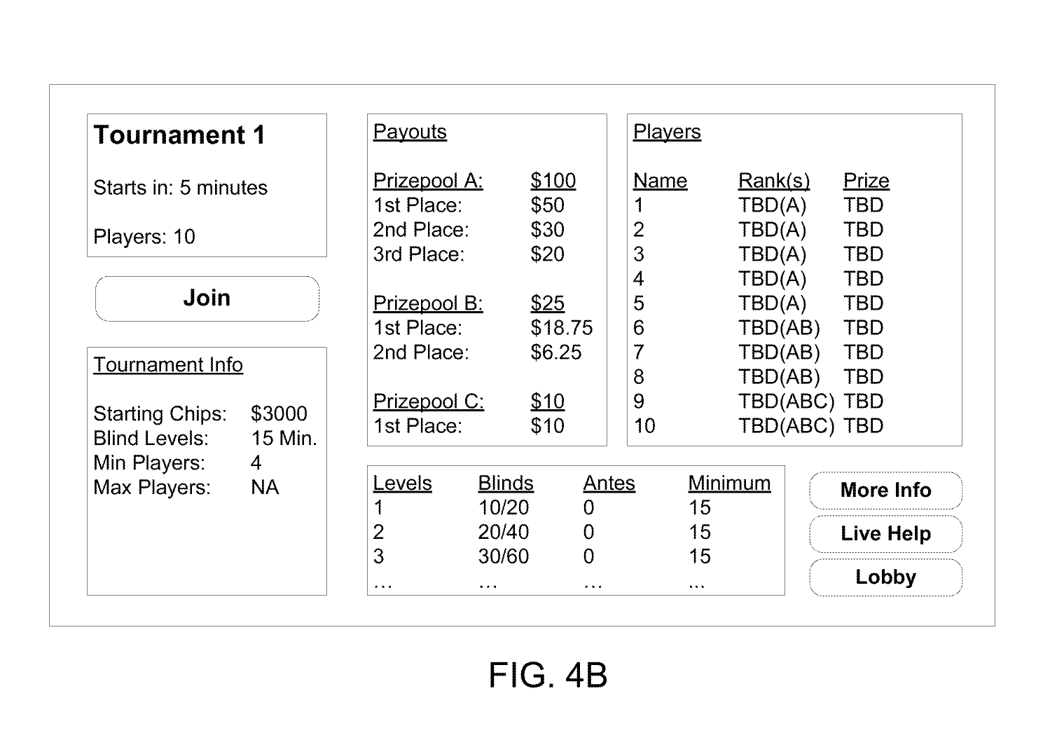

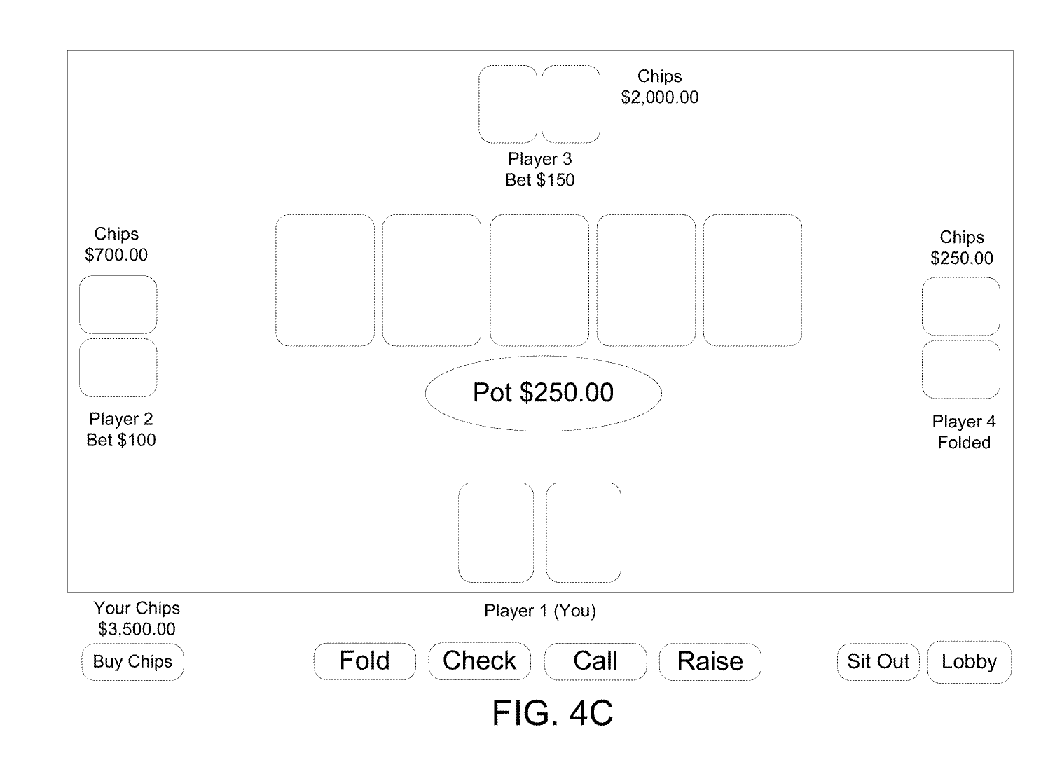

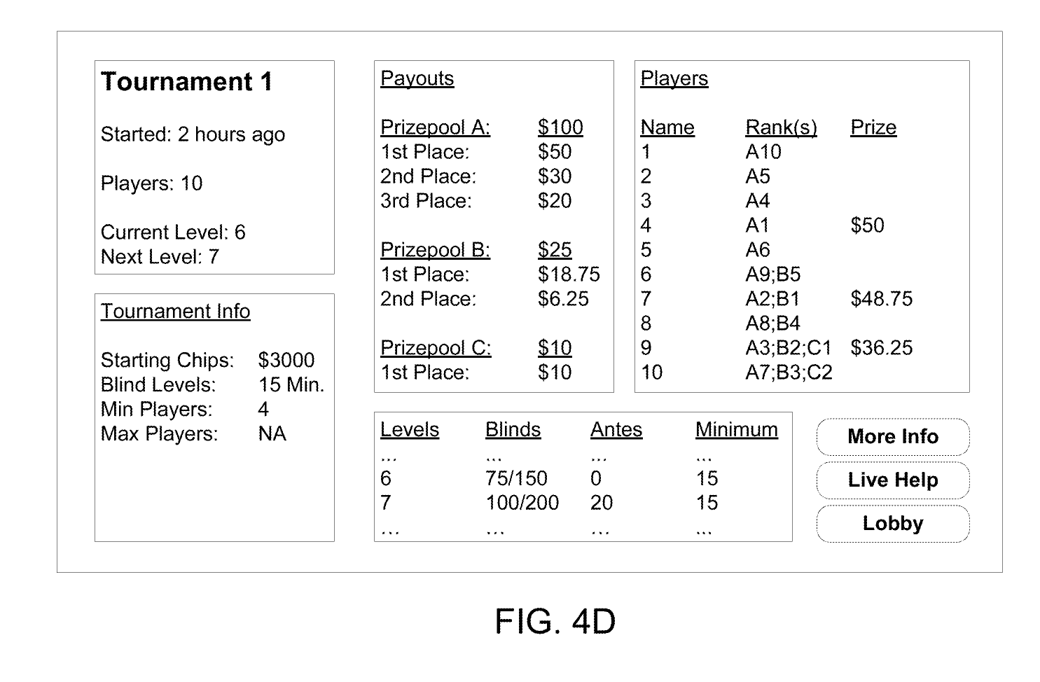

Exemplary user interface views that may be implemented in some embodiments in managing administration of an online poker tournament are illustrated in FIGS. 4A, 4B, 4C, and 4D. A user interface view providing a “lobby” window to users that may be used to filter and sort multiple tournaments by various criteria and to allow a user to select a tournament to join is illustrated in FIG. 4A. In some embodiments, the user interface may include filters for any suitable criteria, which may include any or all of exemplary criteria such as start time, game type, bet limit type, buy-in type, and/or any other suitable criteria. Start times may include scheduled (fixed) and “sit-and-go” (flexible) times at which online tournaments may commence. Scheduled start times may be advantageously used with techniques described herein in some embodiments, because they may decrease the motivation for fraud such as that mentioned above. For example, it may be more difficult for a user to deliberately lose to benefit another user in a scheduled tournament because in a scheduled tournament, tables may be assigned randomly for all players at once, whereas in a “sit-and-go” tournament, they may fill as players join the tournament while it is already running.

Game types may include any suitable variation of poker, such as Texas Hold'em, Five Card Stud, Seven Card Stud, Omaha, Omaha Hi-Lo, and/or any other suitable game type(s). Bet limit types may include no limit, pot limit, fixed limit, and/or any other suitable bet limit type(s). Buy-in types may include multiple pre-set buy-ins, multiple user-defined buy-ins, and/or any other suitable buy-in types. Multiple pre-set buy-ins may include more than one specified buy-in amount, such as 10 dollars, 15 dollars, and 20 dollars as in the running example introduced above. Multiple user-defined buy-ins may include more than one manually entered buy-in amount, such as the example of 8 dollars, 9 dollars, 10 dollars, 14 dollars, 16 dollars, 17 dollars, 21 dollars, 23 dollars, and so on mentioned above. The user interface may also display columns of information regarding each available tournament that meets the selected (shown as emphasized) criteria, including, e.g., start time, tournament name, game type, buy-in type and/or listing of pre-set buy-in tiers, number of players already joined, number of players permitted, and/or any other suitable information. As the server system 110 receives data transmissions from client devices or elsewhere that change information associated with the tournaments or any part of the user interface, the processor(s) 114 may continually update the database and may send data transmissions to continually update the user interface on the client devices with the updated information.

A user interface view providing a tournament information window to a user for an individual tournament before the tournament begins is illustrated in FIG. 4B. In some embodiments, the user interface may include displays of information such as the tournament name, the start time (absolute or relative to the current time), the number of players participating, starting chips, blind levels, minimum players required, maximum players allowed, payouts calculated for each prizepool, participating player names, progressive levels for the course of the tournament, blinds for each level, antes for each level, minimum bets for each level, and/or any other suitable information. The payouts for each prizepool may include a total payout and payouts for specific rank positions, such as first, second, and third “place” or rank positions within the players of the client devices in the set corresponding to each prizepool. In some embodiments, a list of player names may also include the current rank position and any prize to be awarded to each of the players, which will typically be “to be determined” (TBD) before the tournament begins. The user interface may also include user-selectable regions (such as buttons) that allow a user to join the tournament, get more information about the tournament, view live help, or return to the lobby view or window such as that illustrated in FIG. 4A. As the server system 110 receives data transmissions from client devices or elsewhere that change information associated with this tournament or any part of the user interface, the processor(s) 114 may continually update the database and may send data transmissions to continually update the user interface on participating client devices with the updated information.

If the server system 110 receives a request to join a tournament from a client device, the processor(s) 114 of server system 110 may execute instructions to assign the user of that client device to a table, calculate or recalculate the appropriate prizepool(s), and transmit any appropriate information to the client device associated with the tournament, such as the amount of the prizepool(s), the chip amounts of each player in the tournament, player table assignments, and/or the like.

When a tournament begins, the processor(s) 114 of server system 110 may execute instructions to calculate player hands and any other appropriate information and to transmit data indicating the information to the appropriate client devices. For example, transmitting this data may include virtually dealing cards to the players at the table, using, e.g., random number generation to determine which cards in the deck are dealt to each player, and updating in-game graphics and/or other indicators on client device user interfaces to portray the current status of the game. When the first player at a table performs an action such as betting, checking, or folding into the user interface of that player's client device, that client device may transmit data indicating this action to the server system 110 via the network 120 and the network interface 112. The processor(s) 114 of server system 110 may execute instructions to process the data, update the database 119 stored by the data storage media 117 as appropriate, and transmit update data to the client devices associated with the same table. The other users with client devices associated with the same table, the client devices, and the server system 110 may perform corresponding tasks to continue the game and the tournament.

For example, as the game and tournament progress, the processor(s) 114 of server system 110 may execute instructions to continually update the database 119 in real time with information based on player actions and so on. The processor(s) 114 may calculate tournament statistics, running results, such as, for example, updated rankings of players as individuals are eliminated from the tournament, etc., which may be transmitted to the client devices as update data. Server system 110 may also transmit to client devices real-time updated graphic data and/or other indicators to show the game environment and status, including, e.g., what cards a player currently holds, what cards have been revealed on the table, what chips various players hold, the size of the current pot, whose turn it is in the current betting round, etc., as discussed further below.

An exemplary user interface view providing a gaming window to a user during the tournament is illustrated in FIG. 4C. In the particular example of FIG. 4C, the user interface includes a graphic representation of the game table, community cards near the center of the table (e.g., as used in Hold 'em poker games), labels and/or avatars identifying each player at the user's table, cards in each player's hand, the chip amount currently held by each player, the action each player has taken in the current round (e.g., bet $100, bet $150, checked, called, folded, and so on), the pot amount for the current hand, and user-selectable regions allowing the user to buy additional chips, fold, check, call, raise, sit out of a new hand, or return to the lobby view. It should be appreciated, however, that this is merely an example, and embodiments may include any suitable information or regions within such a user interface view, including any, all or none of the examples provided here, and/or including any other suitable components. As the server system 110 receives data transmissions from client devices or elsewhere that change information associated with the game, the tournament, the players, or any part of the user interface, the processor(s) 114 may continually update the database and may send data transmissions to continually update the user interface on participating client devices with the updated information.

An exemplary user interface view providing a tournament information window to a user after the tournament has begun or concluded is illustrated in FIG. 4D. In this particular example, the user interface displays the tournament name, the start time (absolute or relative to the current time), the number of players in the tournament, the current level being played in the tournament, the next level to be played, starting chips, blind levels, minimum players required, maximum players allowed, payouts computed for each prizepool, player names, blinds for each level in the tournament, antes for each level, minimum bets for each level, etc. The payouts for each prizepool may include a total payout and payouts for specific rank positions, such as first, second, and third “place” or rank positions within the prizepool set. The list of player names may also display the rank position and any prize awarded to each of the players. The rank positions listed for individual players may include rank positions for each prizepool in which the player is participating (e.g., based on the player's buy-in tier). For example, player 9 may have a rank position of 3 in prizepool A, 2 in prizepool B, and 1 in prizepool C, as explained further below. The user interface may also include user-selectable regions that allow a user to get more information about the tournament, view live help, or return to the lobby view or window. As the server system 110 receives data transmissions from client devices or elsewhere that change information associated with this tournament or any part of the user interface, the processor(s) 114 may continually update the database and may send data transmissions to continually update the user interface on participating client devices with the updated information.

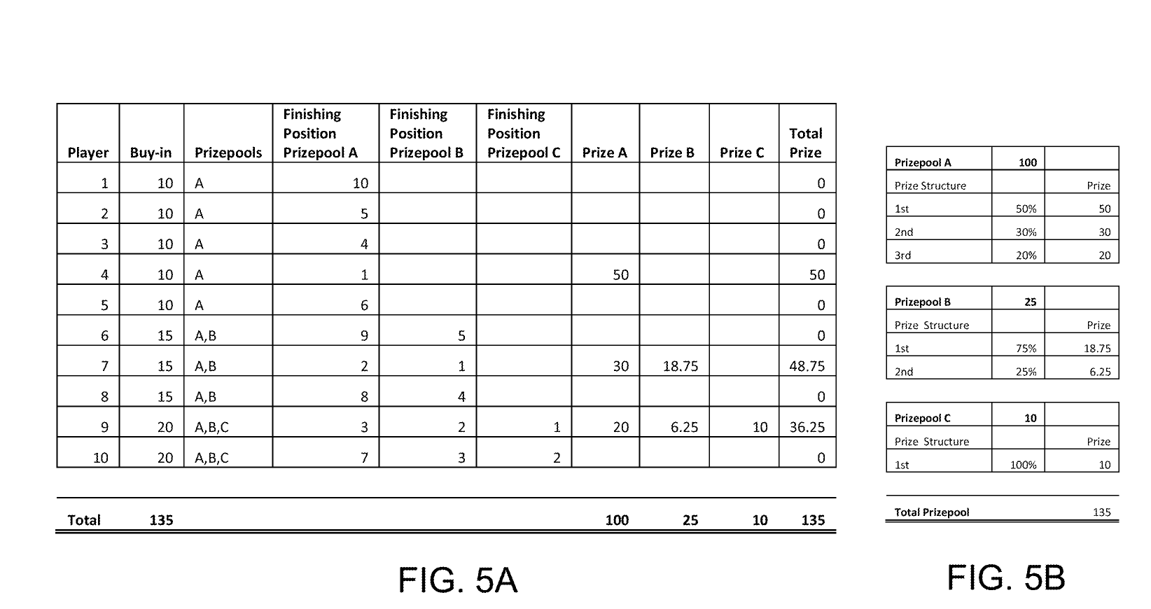

In some embodiments, server system 110 may determine rankings for users in the various prizepool sets based on results of the administered online poker tournament. For example, as the tournament proceeds and concludes, each player may have a “place” or rank position relative to the other players. In some embodiments, these rank positions may be determined by the sequence in which players are eliminated from the tournament, e.g., with players eliminated later being ranked higher than players eliminated earlier. However, this is not required, as any suitable criteria for ranking players may be used. For example, in another embodiment, an online tournament may have a fixed ending time, and players may be ranked at the end of the tournament based on the amount of chips they have left at the ending time. In some embodiments, the rankings for each prizepool set may include the rank position of each player within the respective set. FIG. 5A illustrates a table of exemplary players, buy-in amounts for each player, prizepools in which each player participates on the basis of the buy-in amounts, rank positions for each player in each prizepool, prizes or award amounts for each player in each prizepool, and total prizes or award amounts for each player in accordance with the running example (with buy-in tiers of 10 dollars, 15 dollars, and 20 dollars) introduced above and utilized in FIGS. 3A-3C.

In some embodiments, the processor(s) 114 of server system 110 may execute instructions to determine the rankings of players in a higher prizepool set based on the rankings of the players in a lower prizepool set. For example, in FIG. 5A, the rankings of players 6 through 10 in the second set (prizepool B) are determined based on the rankings of those players in the first set (prizepool A), and the rankings of players 9 and 10 in the third set (prizepool C) are determined based on the rankings of those players in the first set. The players in prizepool A (which includes all 10 of the players in this particular tournament, since it corresponds to the lowest buy-in tier) are ranked in FIG. 5A in positions 1 through 10, e.g., based on their sequence of elimination from the tournament (with player 4 winning the tournament and ranking in position 1 by surviving the elimination of all other players in the tournament). The 5 players participating in prizepool B (by virtue of having contributed buy-in amounts equal to or greater than that of buy-in tier B) are ranked relative to each other in positions 1 through 5, based on their rankings in prizepool A. That is, when disregarding players 1-5 whose buy-in amounts do not qualify for prizepool B, player 7 is then left with the highest ranking (position 2) from the tournament results, player 9 has the next-highest ranking (position 3), player 10 has the next-highest (position 7), and so on. For prizepool B, player 7 thus receives ranking position 1, player 9 receives ranking position 2, player 10 receives ranking position 3, and so on. Similarly for the 2 players in prizepool C (who each contributed buy-in amounts of 20 dollars corresponding to the highest buy-in tier), player 9 ranked highest in the tournament (position 3) when disregarding all players outside of prizepool C, and player 10 ranked next-highest (position 7), giving player 9 ranking position 1 and player 10 ranking position 2 for prizepool C.

In some embodiments, the processor(s) 114 of server system 110 may compute one or more award amounts for each prizepool set, based on the buy-in amounts from appropriate client devices and that set's rankings. For instance, in the example of FIG. 5A, there are 10 total players in the tournament participating in lowest prizepool A corresponding to the 10 dollar buy-in tier. Thus, the total collective buy-in funds available for prizepool A (absent any cut taken by the tournament host or other adjustment to the buy-ins) is 10×$10=$100. The exemplary prize structure set for prizepool A in FIG. 5B allocates 50% of the total prizepool to ranking position 1, 30% to ranking position 2, and 20% to ranking position 3 as award amounts for the first prizepool set. Thus, in this example, the first set award amounts for prizepool A may be computed to be 50 dollars to player 4 for position 1 (i.e., first place) in the first set (prizepool A), 30 dollars to player 7 for position 2 in the first set, and 20 dollars to player 9 for position 3 in the first set.

Prize structures for prizepools may be set in any suitable way, as embodiments are not limited in this respect. In some embodiments, the processor(s) 114 of server system 110 may compute a different distribution of award amounts for one prizepool set than for another set. In some embodiments, this may be based on a different number of client devices being associated to each set. In some embodiments, prizes may be awarded to more players (corresponding to more client devices) in sets having larger numbers of participating players; the specific numbers may be calculated in any suitable way. FIG. 5B illustrates a table of exemplary distributions of award amounts for different sets and prizepools. In this particular example, the first set includes 10 client devices, the second set includes 5 client devices, and the third set includes 2 client devices. The distribution of award amounts in this example includes winnings awarded to 3 client devices in the first set, to 2 client devices in the second set, and to 1 client device in the third set, as shown in FIG. 5B.

The percentages of any total prizepool to distribute to each player ranking specified to receive an award may similarly be determined in any suitable way. Non-limiting example prize structures are provided in FIG. 5B, in which a prizepool (prizepool A) with three awards is divided in a 50/30/20 ratio, a prizepool (prizepool B) with two awards is divided in a 75/25 ratio, and a prizepool (prizepool C) in which there is only one award allocates the entire prizepool to that award. In some embodiments, as in this example, prize structures may be set up such that a greater proportion of the total prizepool is awarded to the highest-ranking player in that prizepool set, and smaller proportions of the total prizepool are awarded to lower-ranking players in the set.

Continuing in FIG. 5B with the example players and buy-in amounts from FIG. 5A, here there are 5 players participating in prizepool B, including players 6-8 in buy-in tier B and players 9 and 10 in buy-in tier C (as discussed above with reference to FIG. 3A). Each of these players contributes to prizepool B the difference between the tier B buy-in amount and the tier A buy-in amount, which is $15−$10=$5, for a total prizepool B amount of 5×$5=$25. Applying the 75/25 prize structure for prizepool B results in award amounts of 75%×$25=$18.75 to player 7 for ranking first in the second prizepool set (prizepool B), and 25%×$25=$6.25 to player 9 for ranking second in the second set. As illustrated in FIG. 5A, player 7 whose tier B buy-in amount qualified for participation in both prizepool A and prizepool B has been awarded two award amounts—one of $30 for ranking second in prizepool A, and one of $18.75 for ranking first in prizepool B—for a total award to player 7 of $48.75. Similarly, players 9 and 10 in this example each contribute to prizepool C the difference between the tier C buy-in amount and the tier B buy-in amount, which is $20−$15=$5, for a total prizepool C amount of 2×$5=$10. Prizepool C supports only one award in this example, and thus the entire $10 is awarded to player 9 who ranked first in the third set (prizepool C). Player 9 in this example has been awarded three award amounts—one of $20 for ranking third in prizepool A, one of $6.25 for ranking second in prizepool B, and one of $10 for ranking first in prizepool C—for a total award to player 9 of $36.25.

It can be seen from this example that, in some cases in some embodiments, a player choosing a higher buy-in amount (such as player 9) may have the opportunity to achieve larger winnings ($36.25 in this example) than he otherwise would have in the same tournament with the same players at a fixed buy-in amount corresponding to the lowest buy-in tier (in which he would have won only $20 in this example). However, a player who wins an award from a higher-buy-in prizepool may not necessarily achieve higher total winnings than a player who wins an award from a lower-buy-in prizepool in the same tournament. In this example, player 4 achieves the highest total award ($50) by ranking first among all the tournament players, even though he only participated at the lowest buy-in tier in the lowest prizepool.

In some embodiments, the processor(s) 114 of server system 110 may execute instructions to transmit, via the network interface 112, notification of computed award amounts to client devices participating in the online tournament. In some embodiments, any suitable rules may be programmed into server system 110 to determine which client devices receive notifications of which awards. For example, in some embodiments, notification of all of the available award amounts may be transmitted to all the client devices, during tournament play (e.g., to inform players as to what awards will be available to winners) and/or upon conclusion of the tournament (e.g., to inform players as to which players received which awards). In other embodiments, a client device may only receive notifications of the available award amounts for the prizepool sets in which the client device is associated (e.g., the available award amounts for which the client device's user is actually competing), and in some embodiments, notifications of the final assignment of award amounts to players may only be transmitted to the client devices of the recipients of the awards.

While exemplary functionality of managing online poker tournaments has been described herein with reference to a server system 110, in some embodiments, any or all of the functions described herein as being performed by the server system 110 may be performed by one of the client devices participating in the online tournament, or in a distributed manner by more than one of the client devices cooperatively, as opposed to being performed by one or more separate server devices. For example, in some embodiments, client devices may be in communication via a peer-to-peer network that allows one or more of the client devices to operate as the server system 110, potentially while also operating as a participant client device in the tournament.

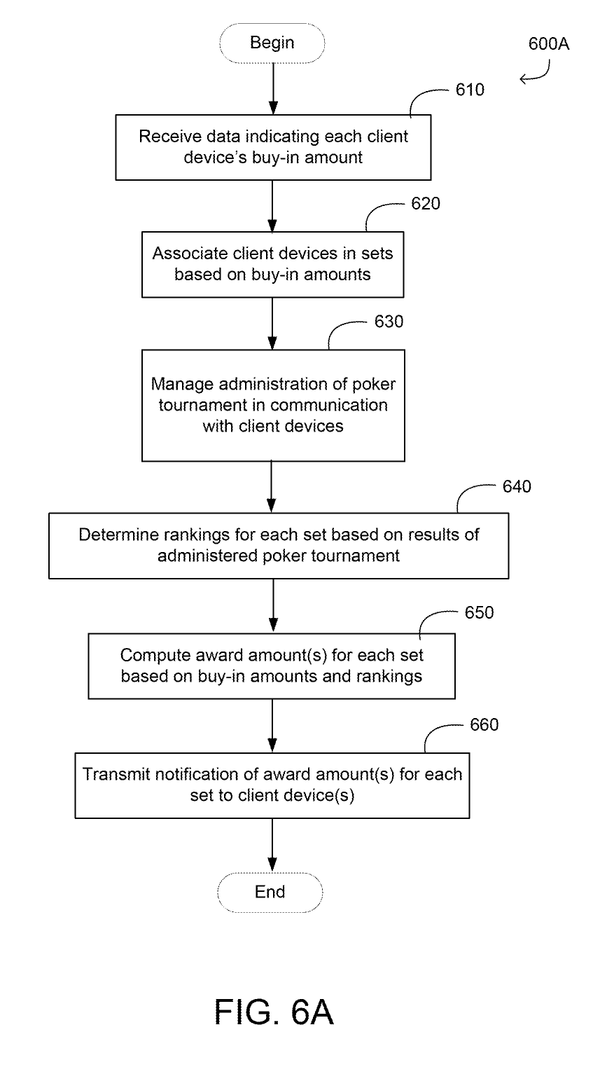

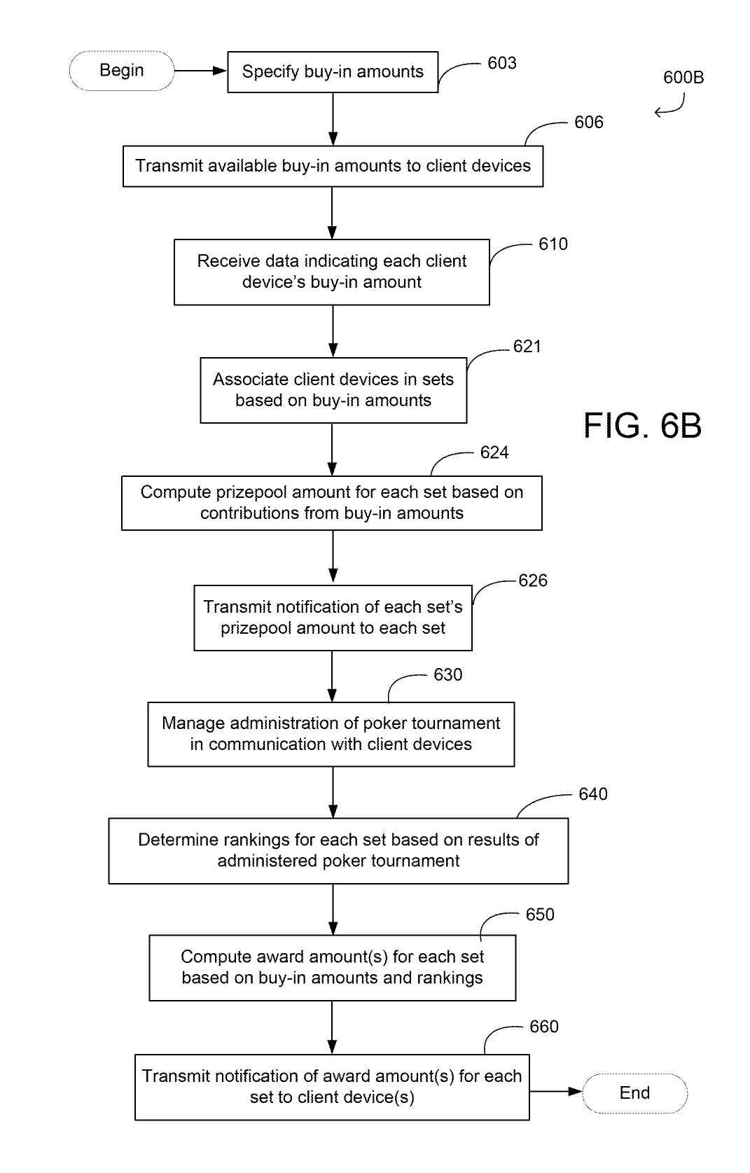

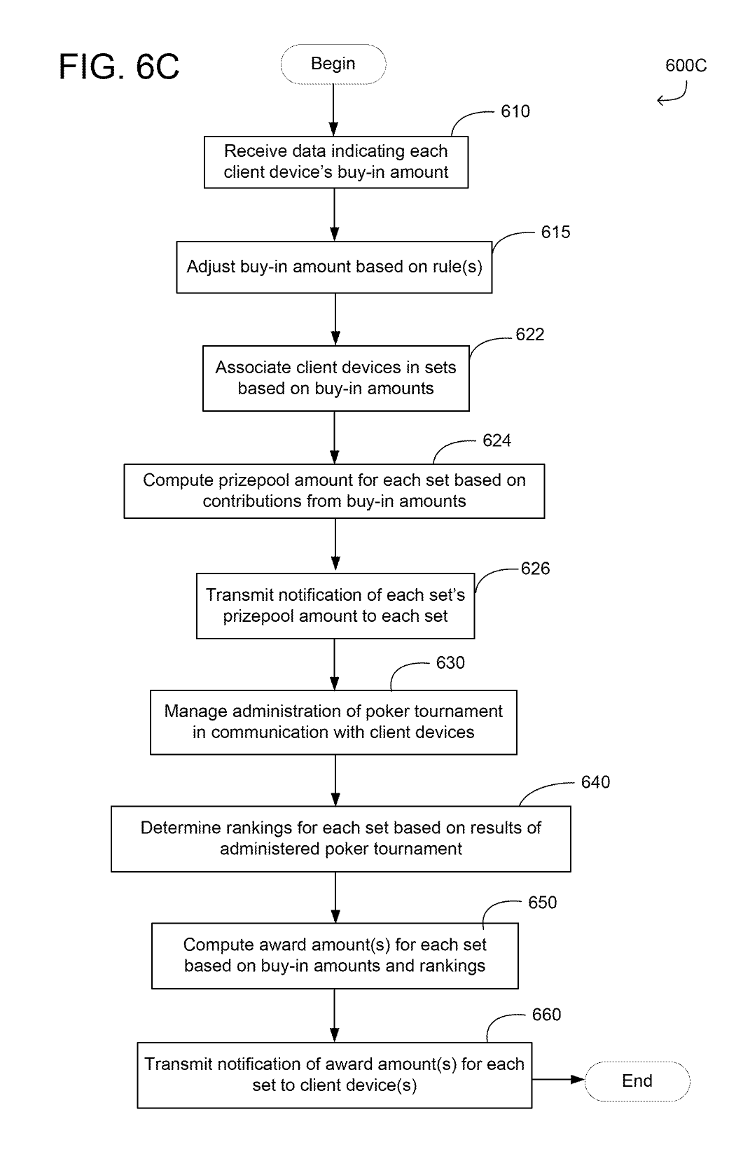

It should be appreciated from the foregoing that one embodiment is directed to a method 600A for managing an online poker tournament allowing joint play between players posting different buy-in amounts, as illustrated in FIG. 6A. Method 600A may be performed, for example, by one or more processors of a control system such as server system 110, although other implementations are possible, as method 600A is not limited in this respect. Method 600A begins at act 610, at which data transmissions indicating buy-in amounts to participate in the online poker tournament may be received from the client devices. As discussed above, in some embodiments a buy-in amount from some of the client devices (e.g., the first client device 130 and the second client device 140) may be different from a buy-in amount from other client devices (e.g., the third client device 150 and the fourth client device 160).

Method 600A then proceeds to act 620, at which the client devices may be associated in sets based on the buy-in amounts received from the client devices. For example, the server system 110 may associate the first client device 130, the second client device 140, the third client device 150, and the fourth client device 160 in a first set, the third client device 150 and the fourth client device in 160 a second set, etc., as discussed in examples above. Method 600A then proceeds to act 630, at which the server system 110 may manage administration of the online poker tournament in communication with the client devices. In some embodiments, as discussed above, this may include administering at least one hand in the online poker tournament in which users of the client devices in all the sets may participate in the same hand.

Method 600A then proceeds to act 640, at which rankings of users may be determined for each set based on results of the administered online poker tournament. Exemplary techniques for determining such set rankings are discussed above. Method 600A then proceeds to act 650, at which one or more award amounts may be computed for each set based on the buy-in amounts and the set rankings. Method 600A ends at act 660, at which the server system 110 may transmit, for each set, notification of at least one of the set award amounts to at least one client device in the respective set.

It should be further appreciated from the foregoing that another embodiment is directed to a method 600B for managing an online poker tournament allowing joint play between players posting different buy-in amounts, as illustrated in FIG. 6B. Method 600B represents an exemplary method in which multiple buy-in amounts for the online poker tournament are centrally specified, as discussed above. Method 600B may be performed, for example, by one or more processors of a control system such as server system 110, although other implementations are possible, as method 600B is not limited in this respect. Method 600B begins at act 603, at which the server system 110 may specify a buy-in amount for each available buy-in tier.

Method 600B then proceeds to act 606, at which the server system 110 may transmit notification of the specified available buy-in amounts to the client devices. Method 600B then proceeds to act 610, at which the server system 110 may receive one or more data transmissions from each client device indicating which of the specified buy-in amounts is selected by the user of the respective client device for participation in the online poker tournament. Method 600B then proceeds to act 621, at which the server system 110 may associate the client devices in sets based on the buy-in amounts selected by the client devices. As discussed above, in one example, client devices that transmit data selecting a first specified buy-in amount may be associated in a first set, while client devices that transmit data selecting a second specified buy-in amount may be associated in a second set (and potentially in the first set), and so on for other specified buy-in amounts and sets.

Method 600B then proceeds to act 624, at which prizepool amounts may be computed for each set based at least in part on contributions from buy-in amounts from the client devices. Exemplary techniques for computing such prizepool amounts in the case of centrally specified buy-in amounts are discussed above. Method 600B then proceeds to act 626, at which the server system 110 may transmit notification of each set's prizepool amounts to the respective sets of client devices (and in some embodiments to all the client devices). As discussed above, in some embodiments, each client device may also receive notification of which of the set prizepool amounts the user of the respective client device is eligible to compete for.

Method 600B then proceeds to act 630, at which the server system 110 may manage administration of the online poker tournament, in communication with the client devices. As discussed above, in some embodiments, this may include administering at least one hand in the online poker tournament in which users of the client devices in all the sets may participate in the same hand. Method 600B then proceeds to act 640, at which rankings of users in each set may be determined based on results of the administered online poker tournament. Method 600B then proceeds to act 650, at which one or more set award amounts may be computed for each set based on the buy-in amounts and the set rankings. Method 600B ends at act 660, at which the server system 110 may transmit, for each set, notification of at least one of the set award amounts to at least one client device in the respective set.

It should be further appreciated from the foregoing that another embodiment is directed to a method 600C for managing an online poker tournament allowing joint play between users posting different buy-in amounts, as illustrated in FIG. 6C. Method 600C represents an exemplary method in which multiple buy-in amounts for the online poker tournament may be manually/arbitrarily entered by users of client devices, as discussed above. Method 600C may be performed, for example, by one or more processors of a control system such as server system 110, although other implementations are possible, as method 600C is not limited in this respect. Method 600C begins at act 610, at which the server system 110 may receive data transmissions indicating buy-in amounts to participate in the online poker tournament from the client devices. As discussed above, in some embodiments, users may be allowed to specify desired buy-in amounts, e.g., without reference to buy-in amounts centrally specified by server system 110.

Method 600C then proceeds to act 615, at which the server system 110 may accept buy-in amounts indicated by the data transmissions, without specifying a particular buy-in amount for each set of client devices prior to receiving the data transmissions, and/or may adjust a received buy-in amount based on a set of one or more applicable rules. For example, in some embodiments the server system 110 may reject or reduce a buy-in amount indicated in the data transmissions that is greater than about double another buy-in amount indicated in the data transmissions. As discussed above, this is merely one example, and any suitable rules for accepting, rejecting, and/or adjusting received buy-in amounts may be established in various embodiments.

Method 600C then proceeds to act 622, at which the client devices may be associated in sets based on the buy-in amounts received from the client devices, which in some cases may be manually entered. Exemplary techniques for performing such associations are discussed above. Method 600C then proceeds to act 624, at which prizepool amounts may be computed for each set based at least in part on contributions from buy-in amounts from the client devices. Exemplary techniques for computing such prizepool amounts in the case of manually entered buy-in amounts are discussed above. For example, in some embodiments, a first set prizepool amount may be computed based at least in part on the combined buy-in amounts from the client devices in the first set and at least portions of the buy-in amounts from the client devices in the second set (and other sets). A second set prizepool amount may be computed based at least in part on at least portions of the buy-in amounts from the client devices in the second set not included in the first set prizepool amount, etc.

Method 600C then proceeds to act 626, at which the server system 110 may transmit notification of each set's prizepool amounts to the respective sets of client devices (and in some embodiments to all the client devices). As discussed above, in some embodiments, each client device may also receive notification of which of the set prizepool amounts the user of the respective client device is eligible to compete for.

Method 600C then proceeds to act 630, at which the server system 110 may manage administration of the online poker tournament, in communication with the client devices. As discussed above, in some embodiments, this may include administering at least one hand in the online poker tournament in which users of the client devices in all the sets may participate in the same hand. Method 600C then proceeds to act 640, at which rankings of users in each set may be determined based on results of the administered online poker tournament. Method 600C then proceeds to act 650, at which one or more set award amounts may be computed for each set based on the buy-in amounts and the set rankings. Method 600C ends at act 660, at which the server system 110 may transmit, for each set, notification of at least one of the set award amounts to at least one client device in the respective set.

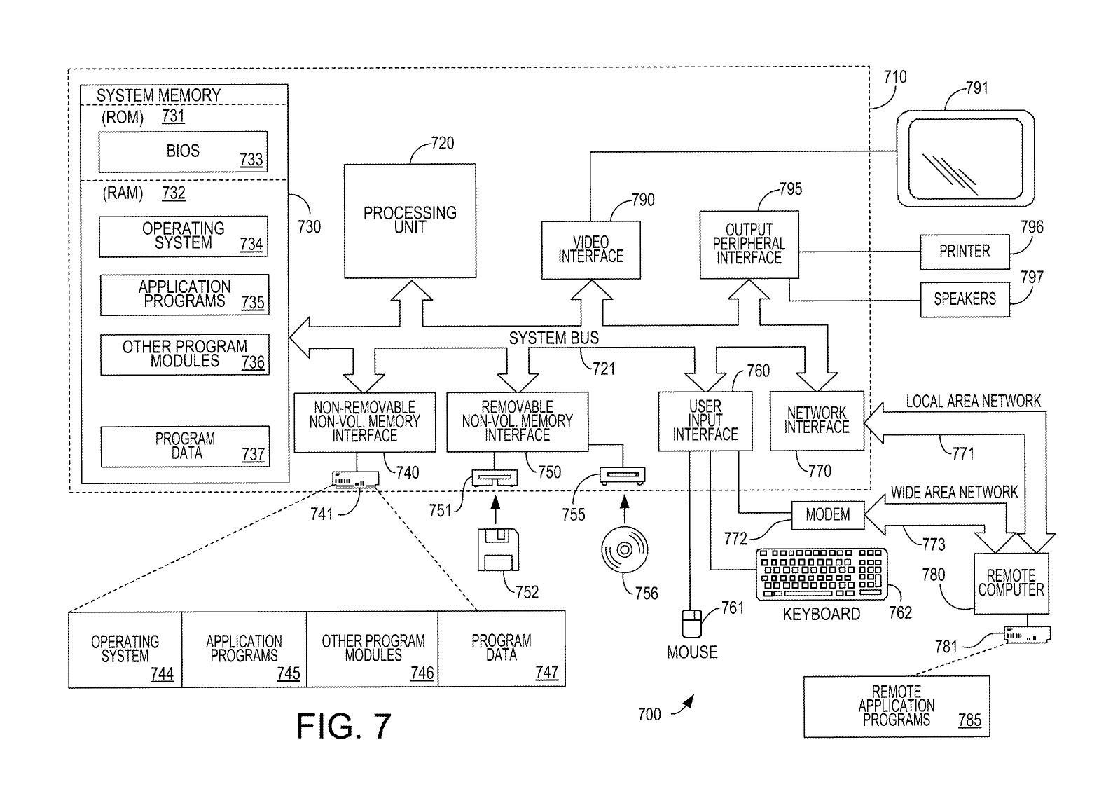

FIG. 7 illustrates an example of a suitable computing system environment 700 in which some embodiments may be implemented. This computing system may be representative of a computing system that allows a suitable control system, such as a server system 110 in some embodiments, to implement the described techniques. However, it should be appreciated that the computing system environment 700 is only one example of a suitable computing environment and is not intended to suggest any limitation as to the scope of use or functionality of the described embodiments. Neither should the computing environment 700 be interpreted as having any dependency or requirement relating to any one or combination of components illustrated in the exemplary operating environment 700.

The embodiments are operational with numerous other general purpose or special purpose computing system environments or configurations. Examples of well-known computing systems, environments, and/or configurations that may be suitable for use with the described techniques include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc., that perform particular tasks or implement particular abstract data types. The embodiments may also be practiced in distributed computing environments where tasks are performed by remote processing devices that are linked through a communications network. In a distributed computing environment, program modules may be located in both local and remote computer storage media including memory storage devices.

With reference to FIG. 7, an exemplary system for implementing the described techniques includes a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7 provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, touchscreen, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation comprises at least one processor-readable storage medium (i.e., at least one tangible, non-transitory processor-readable medium, e.g., a computer memory (e.g., hard drive, flash memory, processor working memory, etc.), a floppy disk, an optical disc, a magnetic tape, or other tangible, non-transitory processor-readable medium) encoded with a computer program (i.e., a plurality of instructions), which, when executed on one or more processors, performs at least some of the above-discussed functions, and possibly others. The processor-readable storage medium can be transportable such that the program stored thereon can be loaded onto any computer resource to implement functionality discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed functionality.

The phraseology and terminology used herein is for the purpose of description and should not be regarded as limiting. The use of “including,” “comprising,” “having,” “containing,” “involving,” and variations thereof, is meant to encompass the items listed thereafter and additional items. Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described several embodiments of the invention, various modifications and improvements will readily occur to those skilled in the art. Such modifications and improvements are intended to be within the spirit and scope of the invention. For example, in some embodiments, the tournament may be played using machines in a casino, not necessarily online, or with physical cards, and the tournament need not be limited to poker, but may involve any suitable wagering game played in a tournament style with buy-ins from players. Furthermore, in some embodiments, multiple users/players may use a single client device that they may rotate between each other or otherwise delineate usage. Accordingly, the foregoing description is by way of example only, and is not intended as limiting. The invention is limited only as defined by the following claims and the equivalents thereto.

What is claimed is:

1. A server system for managing an online poker tournament allowing joint play between users posting different buy-in amounts, the server system comprising:
at least one communication interface configured to communicate over a network with a plurality of client devices including at least a first client device, a second client device, a third client device, and a fourth client device,
at least one processor, and
at least one processor-readable storage medium storing processor-executable instructions that, when executed by the at least one processor, cause the at least one processor to:
receive, via the at least one communication interface, data transmissions indicating buy-in amounts to participate in the online poker tournament from at least the first client device, the second client device, the third client device, and the fourth client device, wherein a buy-in amount from the first client device and a buy-in amount from the second client device are different from a buy-in amount from the third client device and a buy-in amount from the fourth client device;
associate, based on the buy-in amounts, the first client device, the second client device, the third client device, and the fourth client device in a first set of client devices, and the third client device and the fourth client device in a second set of client devices;
manage administration of the online poker tournament, in communication with the first client device, the second client device, the third client device, and the fourth client device via the at least one communication interface;
determine, based on results of the administered online poker tournament, first set rankings of users of the first set of client devices, and second set rankings of users of the second set of client devices;
compute, based on the buy-in amounts and the first set rankings, one or more first set award amounts;
compute, based on the buy-in amount from the third client device, the buy-in amount from the fourth client device, and the second set rankings, one or more second set award amounts;
transmit, via the at least one communication interface, notification of at least one of the first set award amounts to at least one client device of the first set of client devices; and
transmit, via the at least one communication interface, notification of at least one of the second set award amounts to at least one client device of the second set of client devices.

2. The server system of claim 1, wherein managing administration of the online poker tournament comprises administering at least one hand in the online poker tournament in which users of the first client device, the second client device, the third client device, and the fourth client device participate in a same hand.

3. The server system of claim 1, wherein each of the buy-in amounts from the first client device and the second client device is less than each of the buy-in amounts from the third client device and the fourth client device.

4. The server system of claim 1, wherein each of the buy-in amounts from the first client device and the second client device is equal to a first buy-in amount, and each of the buy-in amounts from the third client device and the fourth client device is equal to a second buy-in amount.

5. The server system of claim 4, wherein the processor-executable instructions, when executed by the at least one processor, further cause the at least one processor to:
form a first set prizepool for the users of the first set of client devices from contributions of the first buy-in amount from the first set of client devices; and
form a second set prizepool for the users of the second set of client devices from contributions of a difference between the second buy-in amount and the first buy-in amount from the second set of client devices.

6. The server system of claim 4, wherein the processor-executable instructions, when executed by the at least one processor, further cause the at least one processor to specify the first buy-in amount and the second buy-in amount, and to transmit notification of the specified first and second buy-in amounts to the plurality of client devices prior to receiving the data transmissions indicating the buy-in amounts.

7. The server system of claim 6, wherein specifying the first and second buy-in amounts comprises setting the second buy-in amount to be no greater than about double the first buy-in amount.

8. The server system of claim 1, wherein the processor-executable instructions, when executed by the at least one processor, further cause the at least one processor to accept buy-in amounts indicated by the data transmissions, without specifying a particular buy-in amount for each set of client devices prior to receiving the data transmissions.

9. The server system of claim 8, wherein the processor-executable instructions, when executed by the at least one processor, further cause the at least one processor to reject or reduce a buy-in amount indicated in the data transmissions that is greater than about double another buy-in amount indicated in the data transmissions.

10. The server system of claim 1, wherein the processor-executable instructions, when executed by the at least one processor, cause the at least one processor to compute a different distribution of award amounts for the one or more first set award amounts than for the one or more second set award amounts, based on a different number of client devices being associated to the first set of client devices than to the second set of client devices.

11. The server system of claim 1, wherein the processor-executable instructions, when executed by the at least one processor, cause the at least one processor to determine the second set rankings based on the first set rankings of the users of the second set of client devices.

12. The server system of claim 1, wherein the processor-executable instructions, when executed by the at least one processor, further cause the at least one processor to:
compute a first set prizepool amount based at least in part on the combined buy-in amounts from the first and second client devices and at least portions of the buy-in amounts from the third and fourth client devices; and
transmit, via the at least one communication interface, notification of the first set prizepool amount to the first set of client devices.

13. The server system of claim 12, wherein the processor-executable instructions, when executed by the at least one processor, further cause the at least one processor to:
compute a second set prizepool amount based at least in part on at least portions of the buy-in amounts from the third and fourth client devices not included in the first set prizepool amount;
transmit, via the at least one communication interface, notification of the second set prizepool amount to the plurality of client devices; and
transmit to each client device of the plurality of client devices, via the at least one communication interface, notification of which of the first set and second set prizepool amounts the user of the respective client device is eligible to compete for.

14. The server system of claim 12, wherein the processor-executable instructions, when executed by the at least one processor, further cause the at least one processor to:
compute a second set prizepool amount based at least in part on at least portions of the buy-in amounts from the third and fourth client devices not included in the first set prizepool amount; and
transmit, via the at least one communication interface, notification of the second set prizepool amount to the third and fourth client devices, and not to the first and second client devices.

15. The server system of claim 12, wherein the processor-executable instructions, when executed by the at least one processor, further cause the at least one processor to transmit to each of the plurality of client devices a list of users of client devices in one or more sets of client devices to which the respective client device is associated.

16. A method for managing an online poker tournament allowing joint play between users posting different buy-in amounts, the method comprising:
receiving, via at least one communication interface, data transmissions indicating buy-in amounts to participate in the online poker tournament from a plurality of client devices including at least a first client device, a second client device, a third client device, and a fourth client device, wherein a buy in amount from the first client device and a buy in amount from the second client device are different from a buy in amount from the third client device and a buy in amount from the fourth client device;
associating, based on the buy-in amounts, the first client device, the second client device, the third client device, and the fourth client device in a first set of client devices, and the third client device and the fourth client device in a second set of client devices;
managing administration of the online poker tournament, via execution of stored instructions by at least one processor, in communication with the first client device, the second client device, the third client device, and the fourth client device via the at least one communication interface;
determining, based on results of the administered online poker tournament, first set rankings of users of the first set of client devices, and second set rankings of users of the second set of client devices;
computing, via execution of the stored instructions by the at least one processor, based on the buy-in amounts and the first set rankings, one or more first set award amounts;
computing, via execution of the stored instructions by the at least one processor, based on the buy-in amount from the third client device, the buy-in amount from the fourth client device, and the second set rankings, one or more second set award amounts;
transmitting, via the at least one communication interface, notification of at least one of the first set award amounts to at least one client device of the first set of client devices; and
transmitting, via the at least one communication interface, notification of at least one of the second set award amounts to at least one client device of the second set of client devices.

17. The method of claim 16, wherein managing administration of the online poker tournament comprises administering at least one hand in the online poker tournament in which users of the first client device, the second client device, the third client device, and the fourth client device participate in a same hand.

18. The method of claim 16, wherein each of the buy-in amounts from the first client device and the second client device is less than each of the buy-in amounts from the third client device and the fourth client device.

19. The method of claim 16, wherein each of the buy-in amounts from the first client device and the second client device is equal to a first buy-in amount, and each of the buy-in amounts from the third client device and the fourth client device is equal to a second buy-in amount.

20. The method of claim 19, further comprising:
forming a first set prizepool for the users of the first set of client devices from contributions of the first buy-in amount from the first set of client devices; and
forming a second set prizepool for the users of the second set of client devices from contributions of a difference between the second buy-in amount and the first buy-in amount from the second set of client devices.

21. The method of claim 19, further comprising specifying the first buy-in amount and the second buy-in amount, and transmitting notification of the specified first and second buy-in amounts to the plurality of client devices prior to receiving the data transmissions indicating the buy-in amounts.

22. The method of claim 21, wherein specifying the first and second buy-in amounts comprises setting the second buy-in amount to be no greater than about double the first buy-in amount.

23. The method of claim 16, further comprising accepting buy-in amounts indicated by the data transmissions, without specifying a particular buy-in amount for each set of client devices prior to receiving the data transmissions.

24. The method of claim 23, further comprising rejecting or reducing a buy-in amount indicated in the data transmissions that is greater than about double another buy-in amount indicated in the data transmissions.

25. The method of claim 16, wherein computing the first and second set award amounts comprises computing a different distribution of award amounts for the one or more first set award amounts than for the one or more second set award amounts, based on a different number of client devices being associated to the first set of client devices than to the second set of client devices.

26. The method of claim 16, wherein determining the first and second set rankings comprises determining the second set rankings based on the first set rankings of the users of the second set of client devices.

27. The method of claim 16, further comprising:
computing a first set prizepool amount based at least in part on the combined buy-in amounts from the first and second client devices and at least portions of the buy-in amounts from the third and fourth client devices; and
transmitting notification of the first set prizepool amount to the first set of client devices.

28. The method of claim 27, further comprising:
computing a second set prizepool amount based at least in part on at least portions of the buy-in amounts from the third and fourth client devices not included in the first set prizepool amount;
transmitting notification of the second set prizepool amount to the plurality of client devices; and
transmitting, to each client device of the plurality of client devices, notification of which of the first set and second set prizepool amounts the user of the respective client device is eligible to compete for.

29. The method of claim 27, further comprising:
computing a second set prizepool amount based at least in part on at least portions of the buy-in amounts from the third and fourth client devices not included in the first set prizepool amount; and
transmitting notification of the second set prizepool amount to the third and fourth client devices, and not to the first and second client devices.

30. The method of claim 27, further comprising transmitting to each of the plurality of client devices a list of users of client devices in one or more sets of client devices to which the respective client device is associated.

31. At least one processor-readable storage medium encoded with processor-executable instructions that, when executed by at least one processor, perform a method for managing an online poker tournament allowing joint play between users posting different buy-in amounts, the method comprising:
receiving, via at least one communication interface, data transmissions indicating buy-in amounts to participate in the online poker tournament from a plurality of client devices including at least a first client device, a second client device, a third client device, and a fourth client device, wherein a buy in amount from the first client device and a buy in amount from the second client device are different from a buy in amount from the third client device and a buy in amount from the fourth client device;
associating, based on the buy-in amounts, the first client device, the second client device, the third client device, and the fourth client device in a first set of client devices, and the third client device and the fourth client device in a second set of client devices;
managing administration of the online poker tournament, in communication with the first client device, the second client device, the third client device, and the fourth client device via the at least one communication interface;
determining, based on results of the administered online poker tournament, first set rankings of users of the first set of client devices, and second set rankings of users of the second set of client devices;
computing, based on the buy-in amounts and the first set rankings, one or more first set award amounts;
computing, based on the buy-in amount from the third client device, the buy-in amount from the fourth client device, and the second set rankings, one or more second set award amounts;
transmitting, via the at least one communication interface, notification of at least one of the first set award amounts to at least one client device of the first set of client devices; and
transmitting, via the at least one communication interface, notification of at least one of the second set award amounts to at least one client device of the second set of client devices.

32. The at least one processor-readable storage medium of claim 31, wherein managing administration of the online poker tournament comprises administering at least one hand in the online poker tournament in which users of the first client device, the second client device, the third client device, and the fourth client device participate in a same hand.

33. The at least one processor-readable storage medium of claim 31, wherein each of the buy-in amounts from the first client device and the second client device is less than each of the buy-in amounts from the third client device and the fourth client device.

34. The at least one processor-readable storage medium of claim 31, wherein each of the buy-in amounts from the first client device and the second client device is equal to a first buy-in amount, and each of the buy-in amounts from the third client device and the fourth client device is equal to a second buy-in amount.

35. The at least one processor-readable storage medium of claim 34, wherein the method further comprises:
forming a first set prizepool for the users of the first set of client devices from contributions of the first buy-in amount from the first set of client devices; and
forming a second set prizepool for the users of the second set of client devices from contributions of a difference between the second buy-in amount and the first buy-in amount from the second set of client devices.

36. The at least one processor-readable storage medium of claim 34, wherein the method further comprises specifying the first buy-in amount and the second buy-in amount, and transmitting notification of the specified first and second buy-in amounts to the plurality of client devices prior to receiving the data transmissions indicating the buy-in amounts.

37. The at least one processor-readable storage medium of claim 36, wherein specifying the first and second buy-in amounts comprises setting the second buy-in amount to be no greater than about double the first buy-in amount.

38. The at least one processor-readable storage medium of claim 31, wherein the method further comprises accepting buy-in amounts indicated by the data transmissions, without specifying a particular buy-in amount for each set of client devices prior to receiving the data transmissions.

39. The at least one processor-readable storage medium of claim 38, wherein the method further comprises rejecting or reducing a buy-in amount indicated in the data transmissions that is greater than about double another buy-in amount indicated in the data transmissions.

40. The at least one processor-readable storage medium of claim 31, wherein computing the first and second set award amounts comprises computing a different distribution of award amounts for the one or more first set award amounts than for the one or more second set award amounts, based on a different number of client devices being associated to the first set of client devices than to the second set of client devices.

41. The at least one processor-readable storage medium of claim 31, wherein determining the first and second set rankings comprises determining the second set rankings based on the first set rankings of the users of the second set of client devices.

42. The at least one processor-readable storage medium of claim 31, wherein the method further comprises:
computing a first set prizepool amount based at least in part on the combined buy-in amounts from the first and second client devices and at least portions of the buy-in amounts from the third and fourth client devices; and
transmitting notification of the first set prizepool amount to the first set of client devices.

43. The at least one processor-readable storage medium of claim 42, wherein the method further comprises:
computing a second set prizepool amount based at least in part on at least portions of the buy-in amounts from the third and fourth client devices not included in the first set prizepool amount;
transmitting notification of the second set prizepool amount to the plurality of client devices; and
transmitting, to each client device of the plurality of client devices, notification of which of the first set and second set prizepool amounts the user of the respective client device is eligible to compete for.

44. The at least one processor-readable storage medium of claim 42, wherein the method further comprises:
computing a second set prizepool amount based at least in part on at least portions of the buy-in amounts from the third and fourth client devices not included in the first set prizepool amount; and
transmitting notification of the second set prizepool amount to the third and fourth client devices, and not to the first and second client devices.

45. The at least one processor-readable storage medium of claim 42, wherein the method further comprises transmitting to each of the plurality of client devices a list of users of client devices in one or more sets of client devices to which the respective client device is associated.
